(19) United States
(12) Patent Application Publication
(10) Pub. No.: US 2016/0292950 A1
(43) Pub. Date: Oct. 6, 2016

(54) Method and Apparatus for Authentication of an Element by Encoding and Decoding Position Dependent Signals

(71) Applicants: Yonatan SAVIR, Herzliya (IL); Tomer CZYZEWSKI, Hashita (IL)

(72) Inventor: Ofir Czyzewski, Kibbutz Alumot (IL)

(21) Appl. No.: 15/038,463

(22) PCT Filed: Nov. 25, 2014
(86) PCT No.: PCT/IL2014/051020

§ 371 Date: May 22, 2016

Related U.S. Application Data
(60) Provisional application No. 61/908,376, filed on Nov. 25, 2013.

(51) Int. Cl. G07D 7/00; G06K 19/10; G06K 19/08; G06K 9/00; G06K 9/20; G06K 9/32; G06K 9/62; G06K 7/10; G03H 1/00

(52) U.S. Cl. CPC G07D 7/0013; G06K 7/10663; G06K 19/10; G06K 19/086; G03H 1/0011; G06K 9/2063; G06K 9/3216; G06K 9/6202; G06K 9/00201; G03H 2001/2244

(57) ABSTRACT

The present invention relates to computerized methods, systems and apparatuses for encoding and/or decoding of information in a pattern which emits or reflects position dependent signals, wherein said pattern is either a real 3D pattern or a virtual 3D pattern.

### FIELD OF THE INVENTION

The present invention relates to methods, systems and apparatus for encoding/decoding of information in a pattern which emits or reflects position dependent signals. Specifically, the present invention provides methods, systems and devices for the authentication of elements, e.g. a security element, which contain a three-dimensional (3D) object. The method, systems and devices of the invention allow the identification of objects, such as products and goods, identity and transactions.

### BACKGROUND OF THE INVENTION

Counterfeit products, credit card fraud and stolen identity have become more common than ever. Moreover, the technology used by counterfeiters is as advanced as the technology used by the authorities in their war against counterfeit and fraud. Therefore, a need exists for better security elements and simpler authentication means.

The common security elements use two dimensional patterns such as two dimensional (2D) barcode and common holograms. Although these 2D patterns might be unique, they are relatively easy to reproduce using commercial scanners and printers. Other methods utilize a three-dimensional (3D) pattern to cope with the reproducibility challenge. Reproducing an identical 3D pattern is much more difficult than reproducing a 2D pattern. However, to this date, the automatic identification methods for 3D objects are complex and require highly accurate cameras or sensors. As a result, they are not in common use and when 3D patterns are used they require a human to look at them for authentication or to perform another manual operation.

Some of these methods use random and/or stochastic process to create a 3D pattern and by that guarantee uniqueness and non-reproducibility. However, these methods require a unique, and often expansive, technology which is optimized for a very specific type of 3D patterns or shapes.

### SUMMARY OF THE INVENTION

In certain embodiments, the present invention provides a computerized method comprising a processor and memory for authenticating an authentication pattern 300 on a security element 100, said security element 100 comprising (a) at least one pattern 300 that emits or reflects signal(s); (b) at least one implemented gauge marker 200; and (c) optionally, a unique serial pattern 400, said method comprising: (i) using at least one sensor 500 for capturing via the processor and memory at least one still appearance of (1) said at least one pattern 300; (2) of said at least one gauge marker 200; and (3) of said optional unique serial pattern 400; (ii) identifying via the processor at least one implemented gauge marker 200 in said at least one captured still appearance; (iii) calculating by the processor and memory the relative position and/or relative motion of said security element 100 in relation to the at least one sensor 500 based upon the identified at least one implemented gauge marker 200; (iv) reconstructing and/or identifying the features of said authentication pattern 300 based upon the calculated position of the security element 100 in relation to the sensor 500; and (v) authenticating said authentication pattern 300, wherein said authentication pattern 300 is a either a real 3D authentication pattern or a virtual 3D authentication pattern, such as an electromagnetic field.

In certain embodiments, the present invention provides an apparatus for authenticating an authentication pattern 300 on a security element 100, said security element comprising (a) at least one pattern 300 that emits or reflects signal(s); (b) at least one implemented gauge marker 200; and (c) optionally, a unique serial pattern 400, said apparatus comprising: (i) at least one sensor 500 for capturing at least one still appearance of (1) said at least one pattern 300; (2) of said at least one gauge marker 200; and (3) of said optional unique serial pattern 400; (ii) a processing unit and/or a memory for: (1) identifying at least one implemented gauge marker 200, (2) calculating the relative position and/or relative motion of said security element 100 in relation to the at least one sensor 500 based upon the identified at least one implemented gauge marker 200, (3) reconstructing and/or identifying the features of said authentication pattern 300 based upon the calculated position of the security element 100 in relation to the sensor 500; and (4) authenticating said authentication pattern 300, and (iii) optionally, a database of the different combinations of (a) authentication pattern 300, (b) gauge marker(s) 200, and (c) serial pattern 400, or a connection to such a database, wherein said authentication pattern 300 is a either a real 3D authentication pattern or a virtual 3D authentication pattern, such as an electromagnetic field.

In certain embodiments, the present invention provides a security element 100 comprising an authentication pattern 300, said security element 100 further comprising: (a) at least one implemented gauge marker 200; and (b) optionally a unique serial pattern 400 associated with said authentication pattern 300 and said at least one gauge marker 200, wherein said authentication pattern 300 is a either a real 3D authentication pattern or a virtual 3D authentication pattern, such as an electromagnetic field.

In certain embodiments, the present invention provides a computerized system adapted for authenticating an authentication pattern 300, said system comprising: (a) a security element 100 comprising said authentication pattern 300, at least one gauge marker 200, and optionally a serial pattern 400; (b) an apparatus for authenticating said authentication pattern 300; and (c) a database holding known combinations of the authentication pattern 300, gauge marker(s) 200, and serial pattern 400, wherein said authentication pattern 300 is a either a real 3D authentication pattern or a virtual 3D authentication pattern, such as an electromagnetic field.

In certain embodiments, the present invention provides a computerized method comprising a processor and memory for decoding information stored on a pattern 300 on an element 100, said element 100 comprising (a) at least one pattern 300 that emits or reflects signal(s); (b) at least one implemented gauge marker 200; and (c) optionally a unique serial pattern 400, said method comprising: (i) using at least one sensor 500 for capturing via the processor at least one still appearance of (1) said at least one pattern 300; (2) of said at least one gauge marker 200; and (3) of said optional unique serial pattern 400; (ii) identifying via the processor at least one implemented gauge marker 200 in said at least one captured still appearance;(iii) calculating by the processor and memory the relative position and/or relative motion of said element 100 in relation to the at least one sensor 500 based upon the identified at least one implemented gauge marker 200; (iv) reconstructing and/or identifying at least part of the features of said pattern 300 based upon the calculated position of the element 100 in relation to the at least one sensor 500; and (v) decoding the information stored on said pattern 300 according to the reconstructed and/or identified features of said pattern 300, wherein said pattern 300 is a either a real 3D pattern or a virtual 3D pattern, such as an hologram or an electromagnetic field, and wherein said method does not require the use of any direct location/position sensing means on the sensor itself.

In certain embodiments, the above computerized method of the invention comprises a processor and memory for decoding information stored in a real or virtual 3D pattern 300 on an element 100, wherein said at least one pattern 300 emits or reflects elevated and lowered signals; said method comprising: (i) using at least one sensor 500 for capturing via the processor at least two still appearances of (1) said at least one pattern 300; (2) of said at least one gauge marker 200; and (3) of said optional unique serial pattern 400; (ii) identifying via the processor said at least one implemented gauge marker 200 in said at least two captured still appearance, and using same for estimating the transformation of the plane of the implanted gauge markers 200, which is a result of the sensor 500 relative motion; (iii) identifying any elevated and/or lowered feature of said captured pattern 300 based upon the distortion occurring when transforming one captured appearance to the other, based on (1) said at least one gauge marker 200, and (2) the calculated position of the element 100 in relation to the at least one sensor 500; (iv) transferring said identified elevated and/or lowered features into “zero” or “one” values, respectively, thereby decoding the information stored on said pattern 300, and (v) comparing the decoded information with a data stored on a database or in the optional unique serial pattern 400.

In certain embodiments, the computerized method of the present invention further comprises an initial step of encoding the information into said pattern 300, wherein said encoding means encoding the information as a real 3D pattern or as a virtual 3D pattern onto said element 100.

In certain embodiments, the present invention provides an apparatus for decoding information from a pattern 300 on an element 100, said element 100 comprising (a) at least one pattern 300 that emits or reflects signal(s); (b) at least one implemented gauge marker 200; and (c) optionally a unique serial pattern 400, said apparatus comprising: (i) at least one sensor 500 for capturing at least one still appearance of (1) said at least one pattern 300; (2) of said at least one gauge marker 200; and (3) of said optional unique serial pattern 400; (ii) a processing unit and/or a memory for: (1) identifying said at least one implemented gauge marker 200; (2) calculating the relative position and/or relative motion of said element 100 in relation to the at least one sensor 500 based upon the identified at least one implemented gauge marker 200; (3) reconstructing and/or identifying the features of said pattern 300 based upon the calculated position of the security element 100 in relation to the sensor 500; and (4) decoding the information according to the identified features of said pattern 300, and (iii) optionally, a database of the different combinations of (a) pattern 300, (b) gauge marker(s) 200, and (c) serial pattern 400, or a connection to such a database, wherein said pattern 300 is a either a real 3D pattern or a virtual 3D pattern, such as an hologram or an electromagnetic field.

In certain embodiments, the present invention provides an element 100 comprising information embedded in a pattern 300, said element 100 comprising: (a) at least one pattern 300; (b) at least one implemented gauge marker 200; and (c) optionally a unique serial pattern 400 associated with said pattern 300 and said at least one gauge marker 200, wherein said pattern 300 is a either a real 3D pattern or a virtual 3D pattern, such as an hologram or an electromagnetic field.

In certain embodiments, the present invention provides a system capable of decoding information from a pattern 300 on an element 100, said system comprising: (a) an element 100 comprising an encoded information in a pattern 300, at least one gauge marker 200, and optionally a serial pattern 400; (b) an apparatus for decoding said information from a pattern 300 on said element 100; and (c) a database holding known combinations of the pattern 300, gauge marker(s) 200, and serial pattern 400.

In certain embodiments, the present invention provides a computerized method comprising a processor and memory for encoding information into a pattern 300 on an element 100, comprising (a) implementing at least one gauge marker 200 into said element 100; (b) creating at least one pattern 300 that emits or reflects signal(s) on said element 100; (c) optionally implementing a unique serial pattern 400 onto said element, (d) using a sensor 500 for capturing via the processor all appearances from different relative positions of (1) said at least one pattern 300; (2) of said at least one gauge marker 200; and (3) of said optional unique serial pattern 400; and (e) storing the collected data into a database and/or imprinting it onto said element 100, e.g. into said optional unique serial pattern 400, wherein said pattern 300 is a either a real 3D pattern or a virtual 3D pattern, such as an hologram or an electromagnetic field.

### BRIEF DESCRIPTION OF THE DRAWINGS

FIG. 1 is a scheme illustrating the security element components, the measurement and the authentication process.

FIG. 2 is a scheme illustrating one possible realization of encoding a string in a 3D pattern.

FIGS. 3A-3C illustrate one possible decoding process that is based on position depended signals.

### DETAILED DESCRIPTION OF THE INVENTION

The present invention provides methods, systems and apparatus for authentication of an element 100, such as a security element, which contains at least one three-dimensional (3D) pattern, or any other pattern which emits or reflects signals that depend on the relative position from the pattern. The present invention allows the identification of objects, such as products and goods, identity and transactions.

Accordingly, the present invention provides a computerized method comprising a processor and memory for decoding information stored on a pattern 300 on an element 100, said element 100 comprising (a) at least one pattern 300 that emits or reflects signal(s); (b) at least one implemented gauge marker 200; and (c) optionally a unique serial pattern 400, said method comprising: (i) using at least one sensor 500 for capturing via the processor at least one still appearance of (1) said at least one pattern 300; (2) of said at least one gauge marker 200; and (3) of said optional unique serial pattern 400; (ii) identifying via the processor at least one implemented gauge marker 200 in said at least one captured still appearance;(iii) calculating by the processor and memory the relative position and/or relative motion of said element 100 in relation to the at least one sensor 500 based upon the identified at least one implemented gauge marker 200; (iv) reconstructing and/or identifying at least part of the features of said pattern 300 based upon the calculated position of the element 100 in relation to the at least one sensor 500; and (v) decoding the information stored on said pattern 300 according to the reconstructed and/or identified features of said pattern 300, wherein said pattern 300 is a either a real 3D pattern or a virtual 3D pattern, such as an hologram or an electromagnetic field, and wherein said method does not require the use of any direct location/position sensing means on the sensor itself.

The term relative position means the position of an object based according to its distance and angle from a measuring sensor. The relative position is based upon a 3 axis determination (X, Y and Z axis) between the object and the sensor. The relative positions also enable to deduce the relative movement of the sensor or the object between at least two different measurements.

The present invention provides methods and apparatuses for authentication of an element 100, such as a security element, wherein said element contains an authentication pattern 300 that emits or reflects signals that depend on the relative position from the pattern. The authentication pattern 300 can be, for example, a 3D structure or a hologram that reflects light, or a magnet that emits an electromagnetic radiation.

Accordingly, the present invention provides a computerized method comprising a processor and memory for authenticating an authentication pattern 300 on a security element 100, said security element 100 comprising (a) at least one pattern 300 that emits or reflects signal(s); (b) at least one implemented gauge marker 200; and (c) optionally, a unique serial pattern 400, said method comprising: (i) using at least one sensor 500 for capturing via the processor and memory at least one still appearance of (1) said at least one pattern 300; (2) of said at least one gauge marker 200; and (3) of said optional unique serial pattern 400; (ii) identifying via the processor at least one implemented gauge marker 200 in said at least one captured still appearance; (iii) calculating by the processor and memory the relative position and/or relative motion of said security element 100 in relation to the at least one sensor 500 based upon the identified at least one implemented gauge marker 200; (iv) reconstructing and/or identifying the features of said authentication pattern 300 based upon the calculated position of the security element 100 in relation to the sensor 500; and (v) authenticating said authentication pattern 300, wherein said authentication pattern 300 is a either a real 3D authentication pattern or a virtual 3D authentication pattern, such as an electromagnetic field.

The invention relates in general to encoding and decoding of information via patterns that emit position dependent signals such as 3D elements. The decoding is illustrated, for the sake of example for authentication purposes, but the invention is applicable in general to any purpose of transmitting and receiving information.

The authentication process according to the present invention utilizes implanted gauge markers 200 on the element 100 to deduce the relative position between the sensor 500 and the pattern 300, or the relative movement and/or positions of the sensor between two different measurements thereof. This is done, contrary to commonly known methods, without the need of a direct location sensing means (such as a GPS or any other triangulation method) on the sensor itself.

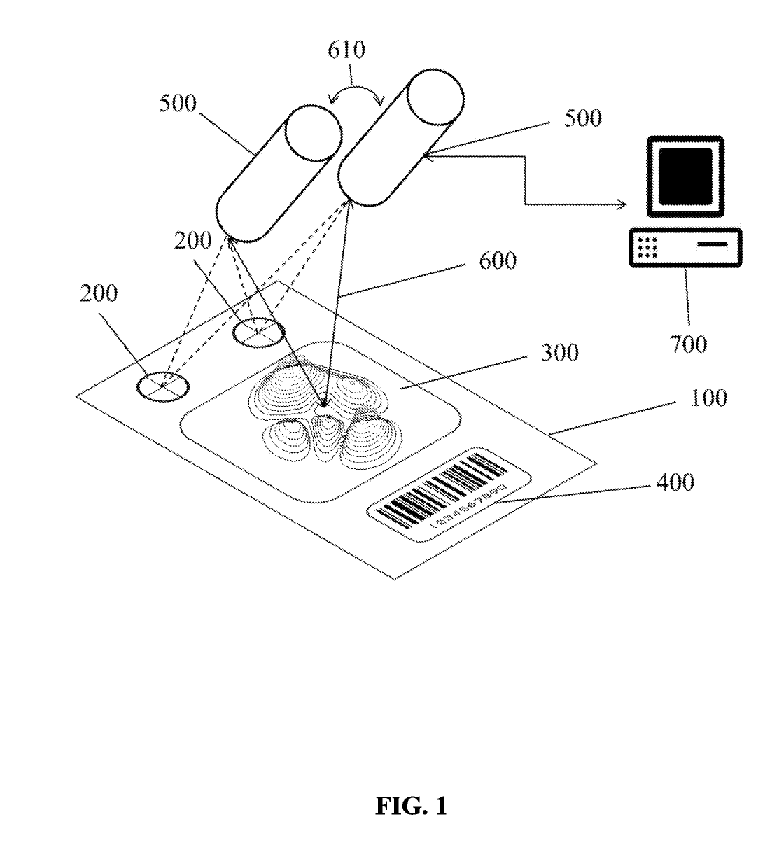

The present invention provides a method and an apparatus for authentication and identification of a security element 100. As shown if FIG. 1, the security element 100 comprises three basic modules: (i) known implanted gauge markers 200, (ii) authentication element with spatial pattern/s 300, and (iii) a unique serial pattern/code 400.

At each measurement (from at least two different relative positions), the sensor 500 captures a signal from the implanted gauge markers 200 and from the authentication pattern 300. By using (i) the prior knowledge about the implanted gauge markers, (ii) the signals from the sensor, and (iii) a dedicated algorithm, the system or device of the invention is capable to deduce (a) the position of the sensor relative to the implanted gauge markers, and/or (b) the relative motion of the sensor 500 or the security element 100, between two, or more, different measurements. This deduction is done without any need for a positioning sensor (such as GPS, compass, accelerator sensor, etc.) on the measuring sensor 500 or on the security element 100.

Since the signal from the authentication pattern 300 depends on its relative position from the sensor 500, deducing the relative position or the relative motion of the sensor relative to the security element 100 enables the verification or reconstruction of the security elements' signals spatial pattern. The verification process is carried out by comparing the spatial features of the measurements with features that are stored in a database and are associated with a unique serial pattern 400.

The above described method and apparatus make counterfeiting of the common authentication patterns used today (like holograms) much harder. Said method and apparatus allow using common sensors (such as a camera and magnetic sensors), and allow using common tools (such as a smart phone) as authentication devices. They also allow using a 3D pattern with random and/or stochastic features that are extremely hard to reproduce, and verifying their authentication with common sensors and devices.

The authentication pattern 300 is any pattern which emits or reflects a signal that depends on the relative position from the pattern. For example, the authentication pattern 300 can be any 3D structure or a hologram that reflects light, or a magnet that emits a magnetic field(s). The authentication pattern 300 can be as simple as a cube or as complex as a random three-dimensional structure or random magnetic field. The goal of the authenticating process is to encode the unique serial code 400 in the authentication pattern 300 so that the decoding will depend on the 3D features of the authentication pattern 300. Thus, only a pattern with unique 3D features could be authenticated as the original pattern.

One of the main challenges of identifying and/or reconstructing a spatial pattern is to know what the relative position/s between the sensor/s and the pattern is, or to know the relative movement of the sensor between several measurements. Moreover, identification of an object when the measured conditions are different (different angles, diverse resolution, varied light conditions, noise, temperature, etc.) constitutes another challenge. The novelty of the present invention is achieved by implanting known gauge markers 200 on a security element 100.

Identifying and/or reconstructing spatial pattern that emits or reflects signal that is changed according to the distance and the position of the measuring sensor/s, require a way of deducing the relative position (on a 3 axis—X, Y and Z) between the sensor and the relevant element, and/or a way to deduce the relative movement of the sensor/s or the relevant element between at least two different measurements 600. The authentication process of the present invention utilizes known implanted gauge markers 200 on the security element 100 for these requirements. Unlike previous methods, a position sensor, such as GPS, compass, accelerator sensor, etc., is not mandatory for the process of the present invention.

At each measurement, the sensor 500 captures a signal from the implanted gauge markers 200 and from the authentication pattern 300. Using prior knowledge about the implanted gauge markers 200, the signals from the sensor/s, and a dedicated algorithm, the position of the sensor 500 relative to the implanted gauge markers 200, and/or the relative movement of the sensor/s or the security element 100 between two different measurements 601, are deduced.

Since the signal emitted from the authentication pattern 300 depends on its relative position from the sensor 500, estimating the sensor relative motion or relative position from the element 100 gives a way to authenticate the 3D features of the authentication pattern 300.

The authentication pattern 300 can be deterministic or randomly designed or with stochastic element (for example: fractures, defects, etc.) or any combination thereof. Accordingly, the pattern 300 is either known before producing, or if it is a result of a random or stochastic process the authentication pattern 300 has to be measured after its creation.

The authentication pattern 300 can be passive or active. The authentication pattern 300 can be optical elements (3D object(s), colored objects having different wavelengths, objects with defined geometry, holograms, etc.), elements which emit or absorb electromagnetic radiation, elements that can be detected by ultrasound or sound, and/or elements with known physical properties (heat capacity, elasticity, life time, etc.). The authentication pattern 300 can be a physical pattern (real structures, printed structure, array of magnets, etc.), or a virtual pattern (hologram(s), lenticular, projected marker(s), etc.). The authentication pattern 300 can also be a combination of any number of different types of authentication patterns, e.g. a hologram combined with a random magnetic field.

All the authentication patterns' data which is collected during the production of the authentication patterns is stored in a database and each data is associated with a unique serial pattern 400, which is/was printed on the element 100. The data can be such as a computer model used for producing the element 100 and/or data which was calculated during and/or after the production process. Once the spatial patterns of the authentication pattern/s 300 and its/their properties have been determined, it/they is/are identified according to the data of the authentication pattern/s with the same unique serial pattern 400 stored in the database.

The implanted gauge markers 200 can be optical elements (e.g. 3D objects, colored objects, objects with defined geometry, holograms, etc.), elements which emit or absorb electromagnetic radiation, elements that could be detected by ultrasound or sound, elements with known physical properties (heat capacity, elasticity , life time, etc.). The implanted gauge markers 200 can be added to the element 100 and can be located within the authentication pattern 300 or at a different location on the element 100. The implanted gauge markers 200 can be physical markers (e.g. real structures, print(s), magnet(s), etc.) or virtual markers (hologram(s), lenticular, projected marker(s), sign(s) or shape(s) on a screen, etc.).

The implanted gauge markers 200 can be used to reduce background noise and enhance the signal of the measurement of the authentication pattern 300. For example, known distance and location information of the implanted gauge markers 200 can be used to enhance the effective resolution of the camera which takes images of the element (e.g. by sub-pixel methods and stabilized methods) and correct optical aberrations.

The unique serial pattern 400 can be any pattern which can be converted to a unique number (for example a serial number) or a unique group (for example spread dots that have uniqueness in a statistical way, such as average distance between the spread dots). The unique group may comprise elements with different properties that the sum of their combination is easily found in the database. The unique group can also use some features located on the authentication pattern 300 itself, e.g. when random and/or stochastic authentication pattern are used. The serial pattern 400 can be a physical pattern (e.g. real structures, prints, etc.) or a virtual pattern (e.g. hologram, lenticular, projected pattern, etc.).

Each sensor type 500 has its own specific properties. As such, each sensor 500 requires specific implanted gauge markers 200. For example, a sensor for measuring magnetic fields requires different implanted gauge markers 200 than a camera that measures light. The efficiency and novelty of the authentication process according to the present invention are achieved by the freedom to implant optimized and/or better gauge markers for each type of sensor, and use of the knowledge obtained during their identification and/or reconstruction process.

In certain embodiments, the measured signal is light, the sensor 500 is a camera, the implanted gauge markers 200 can be detected by said camera, and the authentication pattern 300 is a 3D object. The camera takes at least two still images (for example from a live video) of the security element 100 from two (or more) different locations/positions, and uses the information about the relative position of the camera 500, to verify and/or reconstruct the entire 3D structure of the authentication pattern 300 or relevant part thereof, even if just a part thereof has been obtained (e.g. when just a slice/sector from the 3D structure was obtained by the camera).

In certain embodiments, the method and system of the invention uses at least one sensor 500 for capturing at least one still appearance of the element 100 and its components (i.e. pattern, gauge markers, serial pattern, etc.) from two (or more) different locations/positions, and uses the information about the relative position of the at least one sensor 500, to verify and/or reconstruct the entire structure of the pattern 300 or relevant part thereof. The different components (i.e. pattern, gauge markers, serial pattern, etc.) can each be on a separate still appearance or some or all of them can be captured in the same still appearance. The term still appearance refers to the capturing of a signal from one relative position. For instance, when the sensor is a camera, still appearance refers to a still image, and when the sensor is designed to identify electromagnetic fields, the still appearance refers to the capturing of the structure or virtual structure of the emitted electromagnetic field. The term still appearance refers to the capturing of the entire pattern 300 and/or gauge marker(s) 200 or parts thereof. For instance, only part, e.g. half, third, quarter, etc., of the pattern 300 may be captured in a still appearance optionally together with part of (or entire) the gauge marker(s) 200, or vice versa.

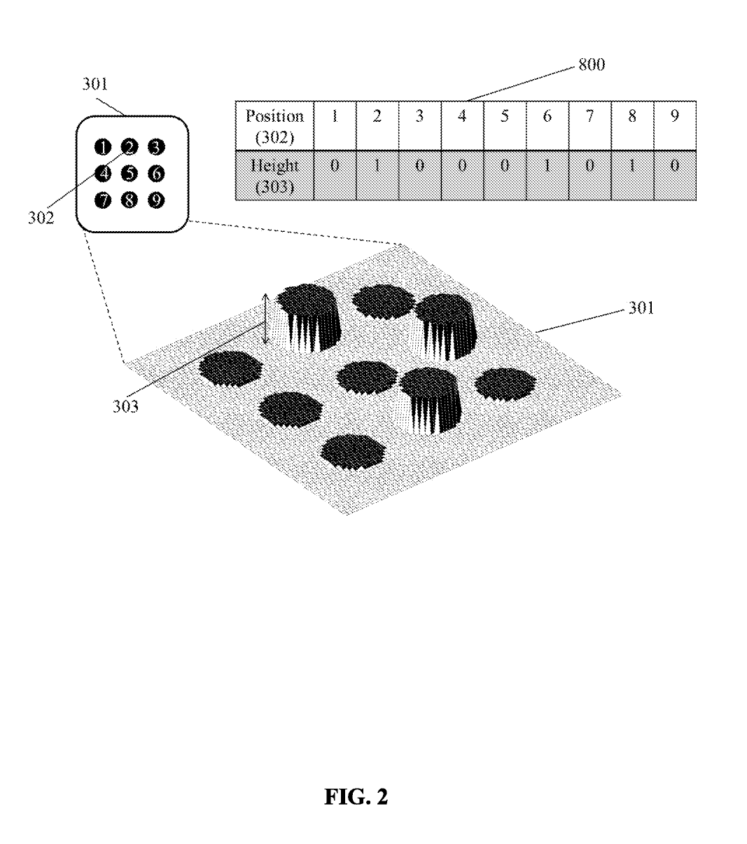

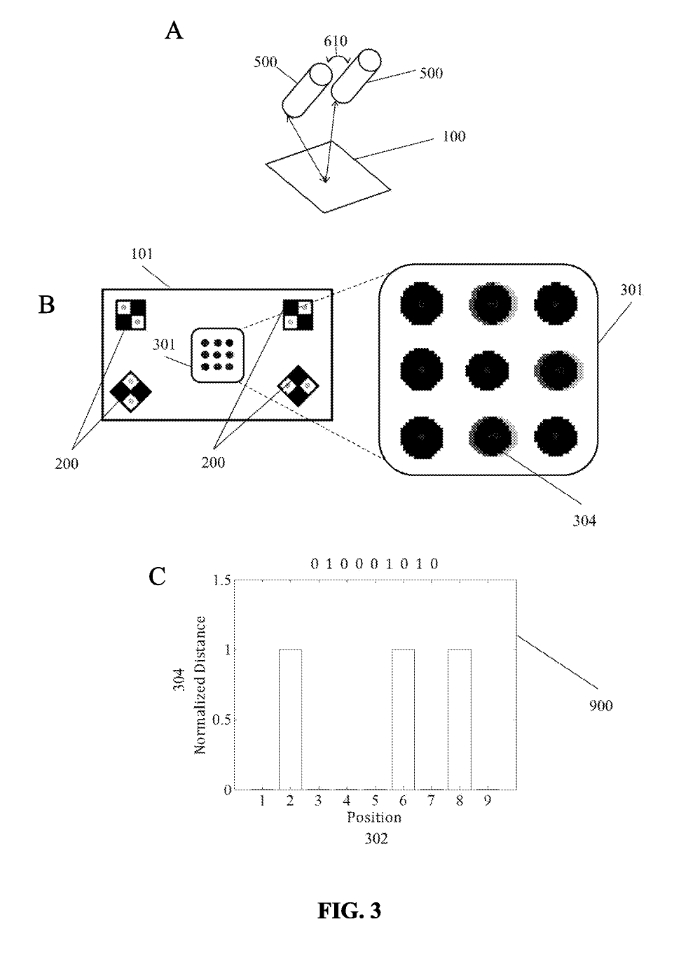

One possible process for efficient producing and identifying a 3D code according to the present invention is illustrated in FIGS. 2 and 3. FIG. 2 illustrates an authentication pattern 301 that is a 3D surface having specific dots spread around in different positions 302 having different heights 303. The mapping between the positions 302 of the dots and their heights 303 creates a unique encoding table 800. For example, in a binary coding scheme shallow dots are associated with ‘zero’ and high/elevated dots are associated with ‘one’.

FIG. 3 illustrates how a camera 500 captures at least two still images, each image from a different position. Recognition of the gauge markets 200 in said at least two images allows estimating the projective transformation of the plane 101 of the implanted gauge markers 200 that is a result of the camera relative motion 610: One image is transformed to the other one by using the calculated transformation. Since the transformation is based on the gauge markers plane 101, any elevated feature (i.e. having a height) which is outside this plane, will not be transformed accurately. As a result, and as shown in FIG. 3B in the differences between the first position image and the transformed image of the second position, the distance 304 between the original position of a dot and the transformed position will be “zero” if the dots reside in the gauge markers plane 101 and “one” if the dots reside in a different plane (FIG. 3C).

Therefore, the distance between the original and the transformed dots maps back to their heights and the estimation of the distances as a function of the positions 900 allows the decoding of the 3D code. This code is compared with the code that was previously saved in the database (associated with the unique number). Said comparison may also use only some of the dots.

Alternatively, only one image taken during the identification process can be used, if the database contains two or more reference images, or when it contains one reference image and data of the properties of the spread dots (their location, height, area, shape, etc.). In such a case, the projective transformation is calculated using the reference image(s) and the new image taken during the identification process. In a similar example, the camera 500 takes a series of images from one position whereas the element 100 moves around, such that in each measurement the focal plane is different.

In certain embodiments, the 3D structure is virtual. For example, it can be a 3D hologram (made by one or more layers), lenticular, projected pattern (e.g. the pattern is saved in, e.g., a smartphone and is projected on a screen by any projector. A picture of the projected pattern is then taken with the camera of the smartphone, and is identified according to the data saved in the database during the producing process), etc. The 3D structure can also be a combination of virtual and real structures. For example, it may be comprised of a hologram and a real structure on the same element 100.

The 3D pattern as describe above can be used as an authentication code, which is compared with a 3D code saved in a database. The same method can be used to create a 3D information code, i.e. a 3D authentication pattern 300, on top of a regular 2D code (such as QR code), so that the final element 100 contains much more information compared to the original regular 2D code. Decoding and encoding a 3D pattern according to the method as describe above is much faster and more robust than reconstructing the full 3D pattern.

In another embodiment, the authentication pattern 300 is a three dimensional array of magnets that creates a different electromagnetic field (i.e. a random field) for each produced array. The intensity of this field as measured by the sensor is dependent on the relative distance and position between the sensor and the authentication pattern(s) 300. In order to find the relative position, a camera or any other type of sensor is used: the implanted gauge markers 200 (for example, implanted gauge markers optimized for camera as describe above) are used to determine the relative position of the magnetic sensor and the array of magnets, which allows verifying the measured intensity according to the expected intensity of the genuine authentication pattern(s) 300 saved in the database.

In another embodiment, two or more measurements from different positions of the array are used while the electromagnetic sensor remains fixed in place, and the expected relative (differential) intensity is calculated. This is achieved by using a camera or any other non-electromagnetic sensor. Since the measured magnetic field is also affected (i.e. changed) by the magnetic field of the poles of the Earth, different positions of the magnetic sensor give different magnetic intensities regardless of the magnetic authentication pattern(s) 300. As a result, this method is more accurate than the regular method.

As described in the embodiments above, the combination of different sensors, different spatial pattern types (e.g. a 3D structure and a magnetic field), and different implanted gauge markers 200, gives the ability to overcome the disadvantages of using only one type of sensor and identification pattern. As such, the method of the present invention also enables to produce larger variety of authentication elements that have, or emit, spatial pattern and subsequently identifying them using the prior knowledge on the implanted gauge markers. It also enables producing more complex spatial patterns (e.g. to prevent counterfeiting) and identifying them with more common means and with higher accuracy compared to the presently used methods.

It should be noted that the above embodiments are just examples of different types of sensors, spatial pattern(s) and implanted gauge markers. It is clear that the claimed methods and apparatuses for authentication can also be obtained by using any type of sensor(s), such as sensors sensitive to wavelength, light, radiation, electromagnetic field, sound, temperature, life time, etc.

Similarly, the element 100 may contain any encoded code, which may be a number or an image or any other pattern (even a file, RFID magnetic media, etc.). Said pattern can be calculated from an element or combination of elements on said element 100. Said pattern is added during the production of each element 100 or it can be attached to any desired product (e.g. credit card, I.D., worker I.D., passport, etc.). Once the authentication pattern(s) 300 has been determined, a new code is created and is compared with the code on the element 100. This procedure can replace a database. Alternatively, it may be the first identifying step before using the database to retrieve the desired data.

All the authentication patterns' data that is collected during the production process are stored in a database and are associated with a unique serial pattern 400. Once the unique serial pattern 400 on the security element 100 has been determined, the data of the authentication pattern 300 with the same unique serial pattern 400 can be found in said database, and the identification process can be executed. The database may contain additional information which can assist in the authentication process (e.g. batch number, time of production, package number, etc.). It may also contain additional information that is related or is not related to the authentication process, such as information on the product, the company, the person, etc. These options can further be combined with track and trace processes.

The element 100 of the invention may be used as a security element and/or high informative element for any purpose, such as for drugs, electrical components, makeup, food, etc.; user identification (e.g. passport, I.D, driving license, places which need password and I.D., worker I.D., etc.); and payment identification means (e.g. credit card, payment via internet or distance payment, etc.).

In certain embodiments, the properties of the element 100, the model of the authentication pattern 300, and the generated code are saved in a database. Each saved model can be much more detailed than just the reconstructed pattern. For instance, it can be calculated with similar device which is used for the authentication process; or it can be calculated with a device different from the one used for the authentication, such as by including more sensors and/or different sensors than those used in the intended authentication device. For example, the authentication device may use only a camera, whereas the original model can be calculated by using both a laser and a camera, or by using different types of camera and lenses, or by using a camera and a magnetic field, etc.

While creating the original spatial pattern model, the measurements' conditions as they are measured according to the implanted gauge markers 200 can be also saved in the database. Accordingly, this information may be used in the future during the verification and/or reconstruction of the authentication pattern(s) 300 process.

The authentication process may use iteration process, wherein in each iteration, a less secure or less complex (for calculating) element is compared, until the full process is achieved and the final spatial pattern(s) of the authentication pattern(s) 300 is compared. For example, comparing a code added to the unique serial pattern 400 at the beginning of the authentication process, may render the full elaborated process of reconstructing the spatial pattern redundant, if the code doesn't match the one stored in the database.

The database can be located in a distance location or on the authentication device (e.g. on a smartphone) or on the authentication system (e.g. a system comprising sensor(s) and a computer). The database can be secured in any level of need. The communication with the database (communication between the authentication device or system and the computer/storage device were the database is located) can be either a secured connection or an unsecured one.

The computer used for calculation of the spatial pattern can be located on the authentication device itself or it can be a part of the authentication system. It may be local, or remote. The authentication process can be done on a single computer or on several computers, and it can be done in parallel or serial.

In certain embodiments, the element 100, e.g. a security element, contains implanted gauge markers 200 optimized for deducing the relative position of a camera 500 and the element 100, and implanted gauge markers 200 optimized for optics distortion correction. Said element 100 may also contain random rough surface having a volume, e.g. a thick polymer sprayed with sand or other grained material. Such a surface can be used as an authentication pattern 300. The security element 100 may further include a unique number, e.g. a barcode with unique number, implanted thereon.

In certain embodiments of the method of the invention, images from different positions are taken, wherein the relative position of the camera 500 and the implanted gauge markers 200 is deduced for each measurement. Optic aberrations are corrected by using the optimized implanted gauge markers 200 for optic distortion corrections for each measurement. Then, by using the unique number implemented on the element 100 (the barcode for example), the 3D structure of the surface is verified by comparing it to the saved 3D model stored in the database. The advantage of the method of the invention is that contrary to the known methods, no specific 3D pattern, no specific shapes in the pattern and/or no specific position of the camera (sensor) are needed when manufacturing and identifying the element 100.

In certain embodiments, the present invention provides an efficient way for producing and identifying a 3D code. The method includes implanting a 3D pyramid (e.g. a square-based pyramid) with different signs on each of its sides as implanted gauge markers 200 on the element 100. The authentication pattern 300 is also a 3D square-based pyramid, similar to the implanted gauge markers. On each side of the authentication pattern's pyramid, dots are spread in different positions and/or shapes. In the first step of this exemplified authentication method, the relative position of a camera and the implanted pyramid is deduced according to the signs detected on the sides of the pyramid. In the second step, the spread dots (location, size, shape, etc.) on the observed side of the authentication pattern 300 are compared and verified according to the data stored in the database. The optional third and fourth steps are identical to the first and second steps, only from a different viewing position (according to the signs on a different side of the pyramid). Although even a single side of the pyramid can be used to authenticate the security element, the above steps can be carried out for all sides of the pyramid for better accuracy. Scale can be deduced according to the size and shape of the relevant side. In certain embodiments, the pyramids and the signs thereon may be a virtual 3D element, e.g. a hologram.

It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on an Intel™ processor, which is adapted to communicate with the computer. Any number and type of machines may be in communication with the computer.

The invention will now be illustrated by the following non-limiting examples.

### EXAMPLES

### Example 1

### Examples of the Authentication 3D Pattern

The authentication 3D pattern is a real 3D pattern made by any of the following methods:
1. Sunken pattern in a material, e.g. polymer, metal, glass, wood, etc.
2. Protuberance over a material, e.g. polymer, metal, glass, wood, etc.
3. Patterns that are the result of a chemical and/or physical reaction, e.g., melting, etc.

14. Imprinting or mimicking a biological pattern, such as leaf, wood, flower, cell, etc. Such patterns are unique and unpredictable.

The authentication 3D pattern is an imaginary 3D pattern:
1. Any type of hologram which creates different image/pattern from different positions, even if each pattern is a 2D image/pattern.
2. Lenticular.
3. Diffractive material creating a 3D pattern.
4. Diffractive material creating different images/patterns from different positions, even if each image/pattern is a 2D image/pattern.
5. Projected pattern from various sources which create different patterns from different positions.

The authentication 3D pattern is selected from:
a. magnetic field transmitter/receiver/generator;
b. acoustic field transmitter/receiver/generator;
c. electromagnetic field transmitter/receiver/generator;
d. wavelength transmitter/receiver/generator; and
e. frequency transmitter/receiver/generator, or any combination thereof.

### Example 2

### Examples of the Gauge Markers

The gauge markers can be a 1D, 2D or 3D pattern, and can be:
a. a real pattern, such as:
   i. a printed pattern.
   ii. a sunken pattern in a material, such as polymer, metal, glass, wood, etc.
   iii. a protuberance over a material, such as polymer, metal, glass, wood, etc.
   iv. a pattern that is the result of a chemical and/or physical reaction, such as fire, melting, etc.
   v. a pattern that is a result of imprinting or mimicking a biological pattern, such as leaf, wood, flower, cell, etc.
b. an imaginary pattern, such as:
   i. a hologram.
   ii. a lenticular.
   iii. a diffractive material creating a 3D/2D pattern.
   iv. a projected pattern from any source which creates different patterns from different positions.
   v. a shown or a projected 2D pattern on a screen, e.g. a trapeze shape that changes into a square in dependency to the position of the sensor and the gauge marker.

The gauge marker is selected from:
a. magnetic field transmitter/receiver/generator;
b. acoustic field transmitter/receiver/generator;
c. Electromagnetic field transmitter/receiver/generator;
d. wavelength transmitter/receiver/generator; and
e. frequency transmitter/receiver/generator or any combination thereof.

The authentication 3D pattern and the gauge markers can be in order or stochastic. For example, they can be either produced with a 3D printer in a logical order of code or they can be generated by melting a 3D polymer, thus creating a random 3D plane.

The logical order of a code may be generated either randomly each time, or in a repeatable manner

### Example 3

Using a Single Sensor
i. A sensor which is a camera:
   1. The gauge markers 200 are 2D printed marks defining the plane/surface of the security element 100. The plane/surface can be flat or curved. The purpose of the gauge markers 200 is to define the plane/surface from any camera position to enable defining the mathematical transformation of the plane/surface between two or more camera positions. The 3D authentication pattern 300 can be any one of the real 3D pattern or imaginary 3D patterns mention above.
      Optimal transformation of the plane/surface occurs when there is a perfect match, i.e. a point that is located on the plane/surface does not changes/moves between the images taken from two (or more) different positions of the camera, whereas each point that is not on the plane/surface does changes/moves between the images taken from two (or more) different positions of the camera. The observed movement correlates to the distance/height of each point from the plane/surface.
      The same concept as detailed above can be achieved by any 2D visible element for implanted gauge marker form the real and imaginary pattern noted above.
   2. The gauge markers 200 can be a 3D object(s), such as ball, stick, etc. and/or a 2D object(s) as mention above. By using the above mentioned method, each relevant point on the 3D authentication pattern 300 is compared with the movement of the 3D gauge marker 200 for better resolution and height estimation.
   3. The gauge markers 200, as well as the 3D authentication pattern 300 will look different from two different viewing positions. Accordingly, for every viewing position the gauge marker 200 is capable of defining the relevant object. For example, in one viewing position both the gauge marker 200 and the authentication pattern 300 are circles with a known ratio between them; and in a second viewing position, both the gauge marker and the authentication pattern are squares with a known ratio between them. It is noted that the gauge marker object and the authentication pattern object can be of different shapes and may be comprised of a single object or from several objects joined together (e.g. dots).
   4. The gauge markers 200 may be implemented to define the conditions of the surrounding environment of the image capture, e.g. light spread, noise reduction, exposure, image stabilization, lens aberration, etc.
   5. For low-resolution cameras, the gauge markers 200 may be designed such that it would be possible to use the fact that more than one image is taken: the combination of at least two low-resolution images can be used to enhance the effective resolution of the gauge markers 200 by using, for example, small dots or lines in a known distance.
   6. A few 3D gauge markers 200 can be implemented, each one in focus in a different plane.

Accordingly, for each plane only a part or dots of the 3D authentication pattern is in focus.
7. Time change: the gauge markers 200 and the 3D pattern change color or visible feature during time. For each period of time and color pattern, the gauge marker 200 and the 3D pattern are compared with the data base.
ii. A frequency sensor:
   1. The label transmits or reflects two or more different frequencies for different positions. The correlation between the different frequencies is saved in a database and is maintained for each position. Eventually, the frequency sensor measures the frequency correlation in few positions and compares the correlation. One way to create such a pattern is by phase array method, e.g. as used in a radar.
   2. As above, wherein each frequency further contains a code.

### Example 4

Using 2 or More Sensors:
iii. Camera +at least one more camera:
   1. As noted for a single camera above, but fewer positions needed.
   2. Using a 1^{st} camera for a certain wavelength range and a 2^{nd} camera for another wavelength range. For example, the gauge markers 200 are visible for the 1^{st} camera only and the authentication pattern 300 is visible only for the 2^{nd} camera. For this configuration, the authentication pattern 300 can also be 2D as the gauge markers 200 and does not have to be a 3D pattern. The authentication code 300 is compared to the database. All that is mentioned above for a single camera is applicable also for two (or more) cameras.
   3. Using two, or more, cameras with a known distance between them enables to correct/calculate the height of an object. Accordingly, when using two cameras according to the invention it is possible to use also the correct height.
iv. Camera+distance meter:
   1. The distance meter enables to determine the correct distance between the camera and the element/object, and can give the correct size of the object. Now the full size of a 3D pattern located on the object can be calculated with the same method of transformation between different positions.
v. Camera+magnetic field/electrical field/acoustic wave
   1. Visible gauge markers are used as mentioned above for a single camera. The magnetic field is made by array of magnets (or any other suitable means), and is stored in the database. For each position of the camera, the magnetic field is measured, and the correlation between the change of the magnetic field and the camera position or the image transformation is compared.
   2. The same can be done for electrical field or acoustic wave
vi. Camera+frequency
   1. For each position and for any distance of the camera from the object/element, a different frequency is transmitted or reflected. There is a mathematical correlation between the image obtained by the camera and the measured frequency, and this is the authentication method. The frequency source may be the gauge marker 200.
vii. Each unique combination can use more than just one type of each sensor. This can be useful for faster and more accurate decoding and/or authentication processes.

### REFERENCE NUMERALS IN THE DRAWINGS

100 security element

101 difference image

200 gauge markers

300 authentication pattern

301 3D authentication pattern

302 position of a 3D element

303 height of a 3D element

304 Relative distance of a 3D element

400 unique serial pattern

500 sensor

600 relative position of the sensor

610 relative movement of the sensor

700 processing unit

1. A computerized method comprising a processor and memory for authenticating an authentication pattern on the security element of claim 3, said method comprising the steps of:
i. using at least one sensor for capturing via the processor and memory at least one still appearance of (1) said at least one authentication pattern; (2) of said at least one gauge marker; and (3) of said unique serial pattern;
ii. identifying via the processor at least one implemented gauge marker in said at least one captured still appearance;
iii. calculating by the processor and memory the relative position and/or relative motion of said security element in relation to the at least one sensor based upon the identified at least one implemented gauge marker;
iv. reconstructing and/or identifying the features of said authentication pattern based upon the calculated position of the security element in relation to the sensor; and
v. authenticating said authentication pattern,
wherein said authentication pattern is a either a real 3D authentication pattern or a virtual 3D authentication pattern.

2. An apparatus for authenticating an authentication pattern on the security element of claim 3, said apparatus comprising:
i. at least one sensor for capturing at least one still appearance of (1) said at least one authentication pattern; (2) of said at least one gauge marker; and (3) of said unique serial pattern;
ii. a processing unit and/or a memory for:
(1) identifying at least one implemented gauge marker,
(2) calculating the relative position and/or relative motion of said security element in relation to the at least one sensor based upon the identified at least one implemented gauge marker,
(3) reconstructing and/or identifying the features of said authentication pattern based upon the calculated position of the security element in relation to the sensor; and
(4) authenticating said authentication pattern, and
iii. a database of the different combinations of (a) authentication pattern, (b) gauge marker(s), and (c) serial pattern, or a connection to such a database,
wherein said authentication pattern is a either a real 3D authentication pattern or a virtual 3D authentication pattern.

3. A security element comprising an authentication pattern, said security element further comprising:
a. at least one implemented gauge marker; and
b. a unique serial pattern associated with said authentication pattern and said at least one gauge marker,
wherein said authentication pattern is a virtual 3D authentication pattern.

4. A computerized system comprising a processor and memory adapted for authenticating an authentication pattern, said system comprising:
a. the security element of claim 3;
b. an apparatus for authenticating said authentication pattern; and
c. a database holding known combinations of the authentication pattern, gauge marker(s), and serial pattern,
wherein said authentication pattern is a virtual 3D authentication pattern.

5. A computerized method comprising a processor and memory for decoding information stored on a pattern on the element of claim 8 said method comprising:
i. using at least one sensor for capturing via the processor at least one still appearance of (1) said at least one pattern; (2) of said at least one gauge marker 200; and (3) of said unique serial pattern;
ii. identifying via the processor at least one implemented gauge marker in said at least one captured still appearance;
iii. calculating by the processor and memory the relative position and/or relative motion of said element in relation to the at least one sensor based upon the identified at least one implemented gauge marker;
iv. reconstructing and/or identifying at least part of the features of said pattern based upon the calculated position of the element in relation to the at least one sensor; and
v. decoding the information stored on said pattern according to the reconstructed and/or identified features of said pattern,
wherein said pattern is a either a real 3D pattern or a virtual 3D pattern,
wherein said method does not require the use of any direct location/position sensing means on the sensor itself.

6. A computerized method according to claim 5 further comprising an initial step of encoding the information into said pattern as a real 3D pattern or as a virtual 3D pattern onto said element.

7. An apparatus for decoding information from a pattern on the element of claim 8 said apparatus comprising:
i. at least one sensor for capturing at least one still appearance of (1) said at least one pattern; (2) of said at least one gauge marker; and (3) of said unique serial pattern;
ii. a processing unit and/or a memory for:
(1) identifying said at least one implemented gauge marker;
(2) calculating the relative position and/or relative motion of said element in relation to the at least one sensor based upon the identified at least one implemented gauge marker;
(3) reconstructing and/or identifying the features of said pattern based upon the calculated position of the security element in relation to the sensor;
(4) decoding the information according to the identified features of said pattern, and
iii. a database of the different combinations of (a) pattern, (b) gauge marker(s), and (c) serial pattern, or a connection to such a database,
wherein said pattern is a either a real 3D pattern or a virtual 3D pattern.

8. An element comprising information embedded in a pattern, said element comprising:
a. at least one pattern;
b. at least one implemented gauge marker; and
c. a unique serial pattern associated with said pattern and said at least one gauge marker,
wherein said pattern is a virtual 3D pattern.

9. A system comprising a processor and memory adapted for decoding information from a pattern on the element of claim 8, said system comprising:
a. an apparatus for decoding said information from a virtual 3D pattern on said element; and
b. a database holding known combinations of the virtual 3D pattern, gauge marker(s), and serial pattern.

10. A computerized method comprising a processor and memory for encoding information into a pattern on the element of claim 8, comprising
a. implementing at least one gauge marker into said element;
b. creating at least one pattern that emits or reflects signal(s) on said element;
c. implementing a unique serial pattern onto said element,
d. using a sensor for capturing via the processor all appearances from different relative positions of (1) said at least one pattern; (2) of said at least one gauge marker; and (3) of said unique serial pattern; and
e. storing the collected data into a database and/or imprinting it onto said element,
wherein said pattern is a either a real 3D pattern or a virtual 3D pattern.

11. The computerized method according to claim 5, wherein:
a. said at least one sensor in step (i) captures at least two still appearances of (1) said at least one pattern; (2) of said at least one gauge marker; and (3) of said unique serial pattern;
b. said identifying in step (ii) refers to identifying said at least one implemented gauge marker in said at least two captured still appearance,
c. said calculating in step (iii) is calculating and/or estimating the transformation of the plane of the implanted gauge markers, which is a result of the sensor relative motion;
d. said reconstructing and/or identifying in step (iv) refers to identifying any elevated and/or lowered feature of said captured pattern based upon the distortion occurring when transforming one captured appearance to the other, based on (1) said at least one gauge marker, and (2) the calculated position of the element in relation to the at least one sensor;
e. said decoding in step (v) refers to transferring said identified elevated and/or lowered features into a binary code, thereby decoding the information stored on said pattern, and
f. comparing the decoded information with a data stored on a database or in the unique serial pattern.

12. The security element according to claim 3, wherein said virtual 3D authentication pattern is a hologram, an electromagnetic field, a lenticular, a projected marker, a sign or shape on a screen, a combination of a virtual and real structures or any combination thereof.

13. The computerized system according to claim 5, wherein said virtual 3D authentication pattern is a hologram, an electromagnetic field, a lenticular, a projected marker, a sign or shape on a screen, a combination of a virtual and real structures or any combination thereof.

14. The element according to claim 9, wherein said virtual 3D authentication pattern is a hologram, an electromagnetic field, a lenticular, a projected marker, a sign or shape on a screen, a combination of a virtual and real structures or any combination thereof.

15. The system according to claim 11, wherein said virtual 3D authentication pattern is a hologram, an electromagnetic field, a lenticular, a projected marker, a sign or shape on a screen, a combination of a virtual and real structures or any combination thereof.
